(19) United States
(12) Patent Application Publication
(10) Pub. No.: US 2025/0189311 A1
(43) Pub. Date: Jun. 12, 2025

(54) INERTIAL SENSOR AND METHOD FOR MANUFACTURING THE SAME

(71) Applicants: DENSO CORPORATION, Kariya-city (JP); TOYOTA JIDOSHA KABUSHIKI KAISHA, Toyota-shi (JP); MIRISE Technologies Corporation, Nisshin-shi (JP)

(72) Inventors: HIDEAKI NISHIKAWA, Nisshin-shi (JP); YUSUKE KAWAI, Nisshin-shi (JP); ATSUSHI MIZUTANI, Nisshin-shi (JP); AKIRA WADA, Nisshin-shi (JP); KATSUAKI GOTO, Nisshin-shi (JP); KEITARO ITO, Nisshin-shi (JP); SHOTA HARADA, Nisshin-shi (JP)

(21) Appl. No.: 18/939,693

(22) Filed: Nov. 7, 2024

(30) Foreign Application Priority Data
Dec. 6, 2023 (JP) 2023-206274

(51) Int. Cl. G01C 19/5783; G01C 25/00

(52) U.S. Cl. CPC G01C 19/5783; G01C 25/00

(57) ABSTRACT

An inertial sensor includes a mounting substrate, a vibrator, and a connection portion. The mounting substrate has electrodes arranged apart from each other. The vibrator has a hollow rim, and a mounting portion having a mounting surface facing the mounting substrate. The connection portion is disposed between the mounting surface of the mounting portion and the mounting substrate to connect therebetween. The electrodes are arranged in a ring shape around the rim at a distance from the rim. The connection portion has a plurality of linear portions extending linearly along node directions, which are directions along substrate radial directions centering on a mounting center of a connection area between the mounting surface and the mounting substrate and passing through positions of vibration nodes of the rim that vibrates in a resonant mode of n=k, in which k is an integer of 2 or more.

### CROSS REFERENCE TO RELATED APPLICATION

The present application claims the benefit of priority from Japanese Patent Application No. 2023-206274 filed on Dec. 6, 2023. The entire disclosures of the above application are incorporated herein by reference.

### TECHNICAL FIELD

The present disclosure relates to an inertial sensor and a method for manufacturing the same.

### BACKGROUND

In recent years, a system for autonomous driving of a vehicle has been developed. This type of system requires a highly accurate self-position estimation technique. For example, a self-position estimation system including a global navigation satellite system (GNSS) and an inertial measurement unit (IMU) has been developed for so-called level 3 autonomous driving. The IMU is, for example, a six-axis inertial sensor including a three-axis gyro sensor and a three-axis acceleration sensor. In the future, in order to realize a level 4 or higher autonomous driving, the IMU with higher accuracy than the current one is required.

A bird-bath resonator gyroscope (BRG) is considered to be a promising gyro sensor for realizing such a high-accuracy IMU, and is composed of a tiny vibrator with a substantially hemispherical three-dimensional curved surface that vibrates in wine glass mode, mounted on a mounting substrate. Such a vibrator has a quality factor (Q factor), which represents the state of vibration, of 10⁶ or more, so it is expected to have higher accuracy than conventional vibrators.

### SUMMARY

The present disclosure describes an inertial sensor and a method for manufacturing the inertial sensor. According to an aspect, an inertial sensor includes a mounting substrate, a vibrator, and a connection portion. The mounting substrate has electrodes arranged apart from each other. The vibrator has a hollow rim, and a mounting portion having a mounting surface facing the mounting substrate. The connection portion is disposed between the mounting surface of the mounting portion and the mounting substrate to connect therebetween. The electrodes are arranged in a ring shape around the rim at a distance from the rim. The connection portion has a plurality of linear portions extending linearly along node directions, which are directions along substrate radial directions centering on a mounting center of a connection area between the mounting surface and the mounting substrate and passing through positions of vibration nodes of the rim that vibrates in a resonant mode of n=k, in which k is an integer of 2 or more.

### BRIEF DESCRIPTION OF DRAWINGS

Objects, features and advantages of the present disclosure will become more apparent from the following detailed description made with reference to the accompanying drawings. In the drawings:

FIG. 1 is a perspective view of an inertial sensor according to a first embodiment;

FIG. 2 is a cross-sectional view of the inertial sensor taken along a line II-II in FIG. 1;

FIG. 3 is a diagram explaining a first drive mode and a second drive mode in a vibrator resonant mode of n=2;

FIG. 4 is a diagram showing an example of a standing wave vibration pattern occurring in a rim of a vibrator in the resonant mode of n=2;

FIG. 5 is a diagram explaining a first drive mode and a second drive mode in a vibrator resonant mode of n=3;

FIG. 6 is a diagram showing an example of a standing wave vibration pattern occurring in a rim of a vibrator in the resonant mode of n=3;

FIG. 7 is a plan view of the inertial sensor when viewed along an arrow VII in FIG. 1 for explaining a connection portion;

FIG. 8 is a diagram explaining an example of the vibrator and node directions of the vibrator in the resonant mode of n=2;

FIG. 9 is a diagram explaining an example of the vibrator and node directions of the vibrator in the resonant mode of n=3;

FIG. 10 is a cross-sectional view of an inertial sensor of a comparative example;

FIG. 11 is a diagram showing an analysis result of vibration transmission from a vibrator to a mounting substrate in the inertial sensor of the comparative example;

FIG. 12 is a diagram showing an analysis result of vibration transmission from the vibrator to the mounting substrate in the inertial sensor of the comparative example;

FIG. 13 is a diagram showing an example of a process for forming a connection portion;

FIG. 14 is a diagram showing another example of a process for forming the connection portion;

FIG. 15 is a top view of an inertial sensor according to a second embodiment;

FIG. 16 is a top view of an inertial sensor according to a third embodiment;

FIG. 17 is a cross-sectional view of the inertial sensor taken along a line XVII-XVII in FIG. 16;

FIG. 18 is a top view of an inertial sensor according to a fourth embodiment;

FIG. 19 is a cross-sectional view of the inertial sensor taken along a line XIX-XIX in FIG. 18;

FIG. 20 is a cross-sectional view of a modified example of the inertial sensor according to the fourth embodiment;

FIG. 21 is a cross-sectional view of an inertial sensor according to a fifth embodiment;

FIG. 22 is a perspective view of the vicinity of a support portion and a mounting portion of the inertial sensor according to the fifth embodiment; and

FIG. 23 is a perspective view showing a modified example of a shim in the inertial sensor according to the third embodiment.

### DETAILED DESCRIPTION

To begin with, a relevant technology will be described only for understanding the embodiments of the present disclosure.

As a relevant technology of an inertial sensor having a tiny vibrator with a Q factor of 10⁶ or more and mounted on a mounting substrate, there is known an inertial sensor having a vibrator that includes a substantially hemispherical curved portion and a bottomed, cylindrical mounting portion that extends from the apex of the substantially hemispherical curved portion toward the center of the approximately hemispherical shape. The mounting portion of the vibrator is bonded to a mounting substrate, so that the curved portion is hollow and vibrates in a wine glass mode.

The inventors of the present application have studied on such an inertial sensor and newly discovered that, in the inertial sensor having a structure in which the entire bottom surface of the bottomed cylindrical mounting portion of the vibrator is bonded to the mounting substrate, when the vibrator is vibrated in a resonant mode, the vibration energy is partially dissipated from the bonded portion to the mounting substrate. Such dissipation of the vibration energy results in the decrease in the Q factor.

The present disclosure provides an inertial sensor and a manufacturing method thereof, which are capable of suppressing dissipation of vibration energy from a connection portion between a vibrator and a mounting structure, and suppressing the decrease in the Q factor of the vibrator.

According to an aspect of the present disclosure, an inertial sensor includes a mounting substrate, a vibrator, and a connection portion. The mounting substrate has a plurality of electrodes arranged apart from each other. The vibrator has a hollow rim that vibrates in a resonant mode due to an electrostatic force from a part of the plurality of electrodes, and a mounting portion that is connected to the mounting substrate. The mounting portion has a mounting surface that faces the mounting substrate. The connection portion is disposed between the mounting surface of the mounting portion and the mounting substrate. The plurality of electrodes is arranged in a ring shape around the rim at a distance from the rim. A center of a connection area between the mounting surface and the mounting substrate is referred to as a mounting center, a radial direction that extends from a virtual straight line passing through the mounting center in a thickness direction of the mounting substrate as an axis is referred to as a substrate radial direction, and a direction extending along the substrate radial direction and passing through a position of a vibration node of the rim that vibrates in a resonant mode of n=k, in which k is an integer of 2 or more, is referred to as a node direction. The connection portion has a plurality of linear portions extending linearly along the node directions.

Accordingly, in the inertial sensor in which the vibrator is bonded to the mounting substrate, the connection portion is disposed between the mounting portion of the vibrator and the mounting substrate. The connection portion includes the plurality of linear portions extending along the node directions passing through the positions of the vibration nodes of the rim, which vibrated in the resonant mode of n=k. Since the mounting portion of the vibrator is fixed to the mounting substrate via the linear portions of the connection portion, it is less likely that the vibration energy will be dissipated to the mounting substrate via positions corresponding to antinodes of the vibrations of the rim vibrating the resonant mode.

According to an aspect of the present disclosure, a method for manufacturing an inertial sensor includes: preparing a mounting substrate and a vibrator, the mounting substrate having a plurality of electrodes arranged apart from each other, the vibrator having a hollow rim that vibrates in a resonant mode due to an electrostatic force from a part of the plurality of electrodes and a mounting portion having a mounting surface; and bonding the mounting substrate and the vibrator, which is arranged on the mounting substrate so that the mounting surface of the mounting portion faces the mounting substrate, by applying a light to the mounting surface from a side of the mounting substrate. In the inertial sensor, a center of a connection area between the mounting surface and the mounting substrate is referred to as a mounting center, a radial direction that extends from a virtual straight line passing through the mounting center in a thickness direction of the mounting substrate as an axis is referred to as a substrate radial direction, and a direction extending along the substrate radial direction and passing through a position of a vibration node of the rim that vibrates in a resonant mode of n=k, in which k is an integer of two or more, is referred to as a node direction. In the method, the bonding includes forming a connection portion that includes a plurality of linear portions extending linearly along the node directions by applying the light.

Accordingly, in the method for manufacturing the inertial sensor in which the vibrator is mounted on the mounting substrate and bonded to the mounting substrate, the bonding of the mounting portion and the mounting substrate includes the forming of the connection portion that includes the plurality of linear portions extending linearly along the node directions by applying the light.

Embodiments of the present disclosure will be described hereinafter with reference to the drawings. In the following embodiments, the same or equivalent parts are denoted by the same reference numerals.

### First Embodiment

An inertial sensor 1 according to a first embodiment will be described with reference to the drawings.

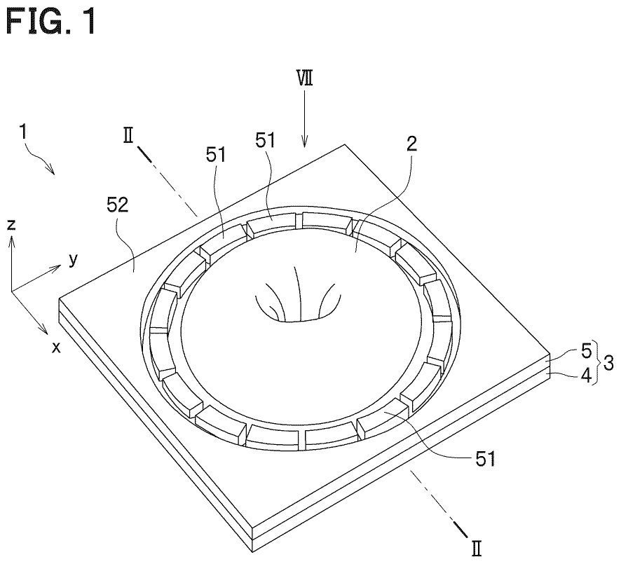

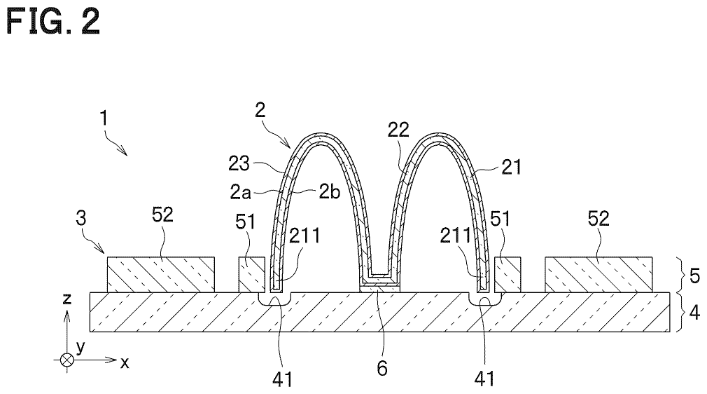

As shown in FIG. 1, for ease of explanation, a direction along a planar direction of a mounting substrate 3 described later will be referred to as the “x direction”, a direction perpendicular to the x direction on the same plane will be referred to as the “y direction”, and a normal direction to an xy plane including the x direction and the y direction will be referred to as the “z direction”. The x, y, and z directions in the views of FIG. 2 and subsequent figures correspond to the x, y, and z directions in FIG. 1, respectively. Further, in this specification, “upper” or “upward” represents a direction along the z direction in the views and represents a direction along the arrow, and “lower” or “downward” represents the opposite direction to the upper or upward. Furthermore, in this specification, a view when the inertial sensor 1, a vibrator 2 described below, or the mounting substrate 3 is seen from above along the z direction will be sometimes referred to as a “top view”.

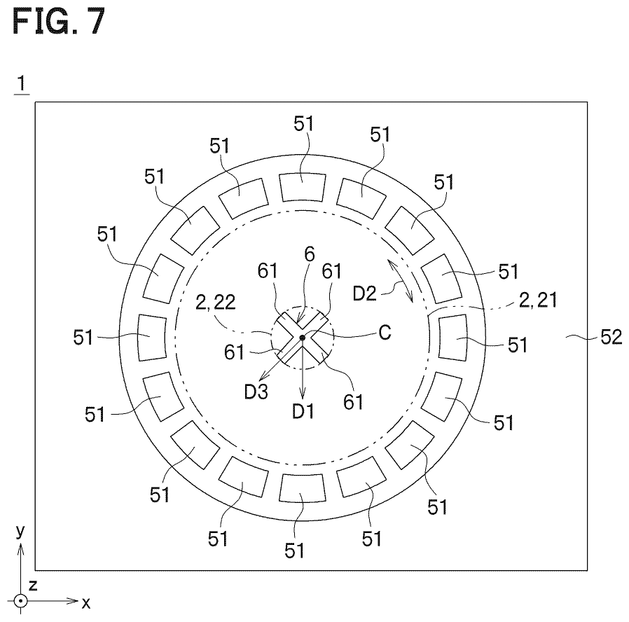

In the top views of FIGS. 4, 6, 8, and 9, the outer contour of a rim 211 of the vibrator 2 (described below) when the vibrator 2 is not vibrating is shown by a solid line, and the outer contour of the rim 211 in a vibration mode is shown by a two-dot chain line. In FIG. 7, a part of the outer periphery of the vibrator 2 is shown by a two-dot chain line, and the outer periphery of a connection portion 6 (described below) located directly below a mounting portion 22 of the vibrator 2 in the top view is shown by a solid line.

### Basic Configuration

The inertial sensor 1 of the present embodiment includes the vibrator 2 and the mounting substrate 3, as shown in FIG. 1, for example. The inertial sensor 1 is capable of detecting the angular velocity applied to the inertial sensor 1 and/or the angle of rotation of the inertial sensor 1 based on the change in capacitance between a rim 211 of the thin-walled vibrator 2, which can vibrate in a first drive mode or a second drive mode, and multiple first electrode portions 51 of the mounting substrate 3. In this specification, it will be described a typical example in which the inertial sensor 1 is configured as a gyro sensor that outputs a signal according to the angular velocity applied thereto.

For example, as shown in FIG. 2, the vibrator 2 is a minute vibrating body having a three-dimensional, substantially symmetrical structure. The vibrator 2 includes a curved surface portion 21 having an outer shape of a substantially hemispherical three-dimensional curved surface, and a mounting portion 22 extending from a vertex of a virtual hemisphere formed by the curved surface portion 21 toward the center of the hemisphere. In the vibrator 2, for example, the curved surface portion 21 has a three-dimensional, bowl-shaped curved surface, and the Q factor of the vibration of the vibrator 2 is 105 or more.

The vibrator 2 has a base including the curved surface portion 21 and the mounting portion 22. The base of the vibrator 2 is made of a reflow material such as quartz glass, glass containing additives such as borosilicate glass, metallic glass, silicon, or the like. However, the material of the base of the vibrator 2 is not limited to the materials mentioned above as long as the base of the vibrator 2 is made of a reflow material that can form the curved surface portion 21 with the three-dimensional curved shape and the mounting portion 22 and can vibrate in a resonant mode of n=k (k: an integer of 2 or more) described below. The vibrator 2 is a thin member in which the curved surface portion 21 and the mounting portion 22 have a thickness of, for example, 10 μm to 100 μm, which is on the order of micrometers. A dimension of the vibrator 2 in a direction along a thickness direction of the mounting substrate 3, that is, a direction orthogonal to the planar direction of the mounting substrate 3 is referred to as a height. The vibrator 2 has a bird-bath shape in a millimeter-size. For example, the height of the vibrator 2 is 2.5 mm, and an outer diameter of the rim 211 defined by a front surface 2a is 5 mm.

The vibrator 2 is produced, for example, by the following manufacturing process. First, a quartz plate having a thickness of 100 μm or less is set in a mold (not shown) that has a recess and a support pillar part at the center of the recess for supporting a part of the quartz plate when being heated and softened. The inside of the recess is evacuated to a vacuum while a part of the quartz plate is softened by a heating means such as a flame. For example, this process causes the portion deformed toward the recess to become the curved surface portion 21, and the portion of the quartz plate supported by the support pillar part of the mold (not shown) to become the mounting portion 22 having a cylindrical recessed shape with a bottomed end. The portion protruding from the recess remains unprocessed, but is removed by any method such as laser processing or polishing to form the base of the vibrator 2. Then, for example, a surface electrode 23 is formed on the base formed in the above process by any film formation method. As a result, the vibrator 2 is produced. The vibrator 2 is produced, for example, by the manufacturing process described above. However, the manufacturing method is not limited to this example, and other known methods may be adopted.

An end portion of the curved surface portion 21 opposite the mounting portion 22 serves as the rim 211, and the rim 211 has, for example, a substantially cylindrical shape. Note that the term “substantially cylindrical shape” includes not only a cylindrical shape in which the diameter from the top to the bottom of the outer and inner surfaces of the rim 211 is the same, but also a cylindrical shape in which the diameter varies from the top to the bottom. In other words, the curved surface portion 21 has the rim 211 that is an annular portion having an annular curved surface shape. When the vibrator 2 is mounted on the mounting substrate 3 with a surface having a larger outer diameter as a front surface 2a and a surface opposite to the front surface 2a as a rear surface 2b, the front surface 2a of the rim 211 faces the first electrode portions 51 of the mounting substrate 3 at intervals therebetween. The vibrator 2 is mounted so that the rim 211 and the multiple first electrode portions 51 are spaced at an equal interval. The vibrator 2 is a hollow part in which the curved surface portion 21 including the rim 211 does not come into contact with other members, when being mounted on the mounting substrate 3. The vibrator 2 has a structure in which, when mounted on the mounting substrate 3, the hollow rim 211 can vibrate in a resonant mode of n=k, and may also be referred to as a resonator.

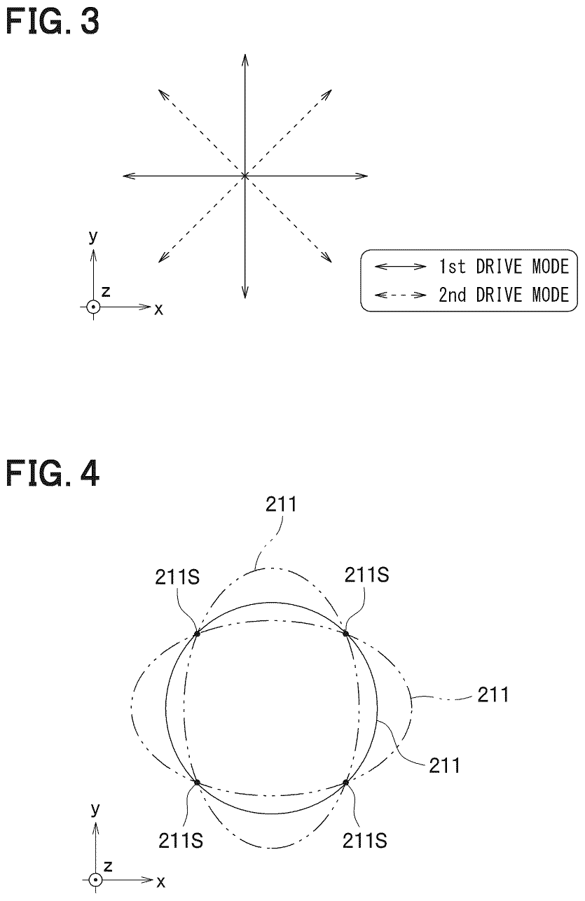

For example, as shown in FIG. 3, in the resonant mode of n=2, a first drive mode in which vibrations occur in directions along solid arrows and a second dive mode in which vibrations occur in directions along dashed arrows are caused in the rim 211 due to the electrostatic force from the driving electrodes of the multiple first electrode portions 51. In the case of the resonant mode of n=2, two second drive modes occur, which is the same number as the first drive modes. Further, the directions of the second drive modes are inclined by 45° relative to the directions of the first drive modes. The first drive modes and the second drive modes have different mode frequencies. In the gyro sensor, in order to improve accuracy, a mode matching control is performed to make the difference in mode frequencies zero by adjusting the electrostatic forces of the drive electrodes. In this case, for example, as shown in the top view of FIG. 4, the rim 211 generates a standing wave vibration pattern in which the outer contour of the rim 211 displaces in a substantially sinusoidal shape, and the vibration pattern has four antinodes and four nodes in the vibration amplitude.

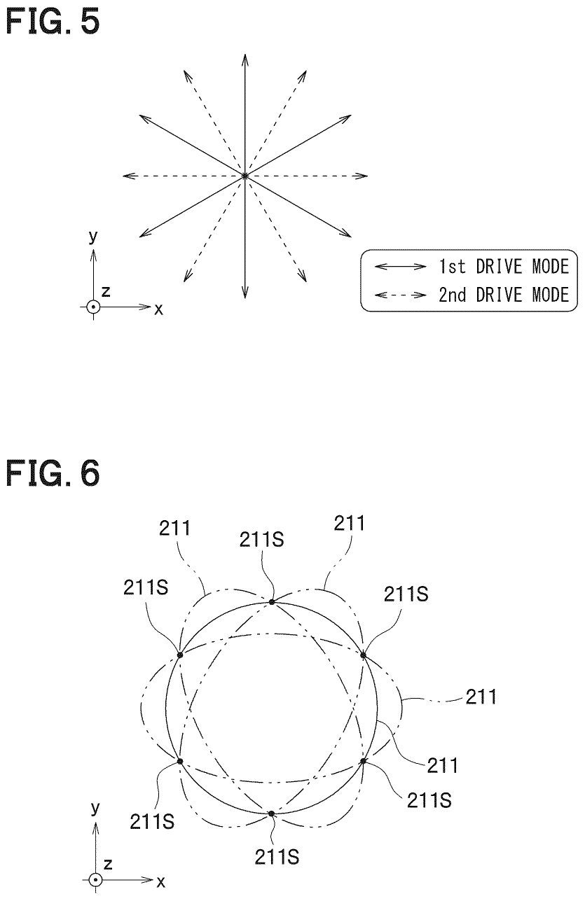

In the case of the resonant mode of n=3, as shown in FIG. 5, for example, the second drive modes having the vibration directions shown by the dashed arrows occur in the rim 211 in directions that are inclined by 30° relative to the vibration directions of the first drive modes shown by the solid arrows. In the case of the resonant mode of n=3, three first drive modes and three second drive modes occur. In a state where the mode matching control is performed in the resonant mode of n=3, the rim 211 generates a standing wave vibration pattern in which the outer contour of the rim 211 is displaced in a substantially sinusoidal shape, when viewed from above, as shown in FIG. 6. In the case of the resonant mode of n=3, the standing wave vibration pattern of the rim 211 has six antinodes and six nodes in the vibration amplitude. The rim 211 may have a higher order resonant mode, that is, have the resonant mode of n=4 or greater. In the case of the resonant mode of n=k, in which k is an integer greater of 2 or higher, the second drive mode occurs in a direction inclined by (180/k) degrees relative to the direction of the first drive mode, and the number of antinodes and the number of nodes in the standing wave vibration pattern of the rim 211 are 2k.

Hereinafter, for ease of explanation, as shown in FIGS. 4 and 6, the node portion of the standing wave vibration pattern that occurs when the rim 211 is vibrated in the resonant mode of n=k will be referred to as the “node 211S”. The connection portion 6, which will be described later, has a configuration corresponding to the number and directions of the nodes 211S in the resonant mode of the rim 211 described above.

The mounting portion 22 is a mounting part that is mounted on the mounting substrate 3 via the connection portion 6 described later. The mounting portion 22 has, for example, a shape of cylindrical recess with a bottomed end. However, the shape of the mounting portion 22 is not limited to the cylindrical recess, and may be substantially a columnar shape. In the case where the mounting portion 22 has the shape of the cylindrical recess with the bottomed end, a bottom surface 22a of the bottom of the recess defined by the front surface 2a can be used as an adsorption surface for adsorbing and transporting the vibrator 2 when the vibrator 2 is mounting on the mounting substrate 3. A surface of the mounting portion 22 opposite to the bottom surface 22a, that is, a surface defined by the rear surface 2b serves as a mounting surface 22b facing the mounting substrate 3.

The surface electrode 23 is formed of, for example, but not limited to, laminated films including an adhesion layer adjacent to a base and a conductive payer laminated on the adhesion layer. The adhesion layer is made of chromium or titanium. The conductive layer is formed on the adhesion layer and is made of any conductive material such as gold or platinum. The surface electrode 23 is formed on the front surface 2a and the back surface 2b of the vibrator 2 by any film formation method such as sputtering, vapor deposition, chemical vapor deposition (CVD), or atomic layer deposition (ALD). The surface electrode 23 is, for example, formed on at least the mounting surface 22b and the front surface 2a of the rim 211, and these portions are thus electrically connected to each other. The surface electrode 23 may have a solid shape that covers the entire front and rear surfaces of the vibrator 2, or may have a pattern shape that is patterned by a photolithography etching method or the like and covers a part of the front and rear surfaces. In the vibrator 2, for example, a portion of the surface electrode 23 that covers the mounting surface 22b of the mounting portion 22 is electrically connected to the mounting substrate 3.

As shown in FIG. 1, for example, the mounting substrate 3 includes a lower substrate 4 and an upper substrate 5, which are bonded to each other. For example, the mounting substrate 3 is obtained by performing etching processing and wiring film formation on the lower substrate 4 made of borosilicate glass, which is an insulating material, then anodically bonding the upper substrate 5 made of silicon, which is a semiconductor material, to the lower substrate 4, and performing patterning. In the mounting substrate 3, for example, multiple first electrode portions 51 and second electrode portion 52 are formed by performing dry etching, such as deep reactive ion etching (DRIE), on the upper substrate 5 which is anodically bonded to the lower substrate 4. The mounting substrate 3 has, for example, a ring-shaped groove 41 formed on the lower substrate 4 so as to surround the region where the mounting portion 22 of the vibrator 2 is connected. The lower substrate 4 is made of a light-transmitting material that transmits at least ultraviolet light or light in other wavelength ranges, so that the connection portion 6, which will be described later, can be formed.

The groove 41 is, for example, as shown in FIG. 2, a ring-shaped groove formed in an inner region of the multiple first electrode portions 51. The groove 41 is, for example, formed by wet etching. The groove 41 has a dimension corresponding to the outer diameter of the rim 211 of the vibrator 2. The groove 41 is provided so that the rim 211 does not come into contact with the mounting substrate 3 when the vibrator 2 is mounted on the mounting substrate 3.

The multiple first electrode portions 51 are arranged apart from each other at an equal interval so as to form a single ring on the xy plane, surrounding the rim 211 of the vibrator 2, for example, as shown in FIG. 1. An electrode film (not shown) is formed on the upper surface of each of the first electrode portions 51. The potential of the multiple first electrode portions 51 can be controlled by, for example, connecting a wire (not shown) to the electrode film (not shown) and electrically connecting the electrode film to an external circuit board or the like. When the vibrator 2 is mounted, each of the multiple first electrode portions 51 is spaced apart a predetermined distance from the rim 211 of the vibrator 2. Each of the multiple first electrode portions 51 forms a capacitor with the vibrator 2, making it possible to detect the electrostatic capacitance between the first electrode portion 51 and the vibrator 2. Some of the multiple first electrode portions 51 serve as detection electrodes that detect the electrostatic capacitance, and the others serve as drive electrodes that apply an electrostatic force to the rim 211 of the vibrator 2.

The second electrode portion 52, for example, has a single frame shape when viewed from above. The second electrode portion 52 surrounds the multiple first electrode portions 51. An electrode film (not shown) is formed on the upper surface of the second electrode portion 52, and a wire (not shown) is connected to the electrode film (not shown). The second electrode portion 52 is configured to be connected to the surface electrode 23 of the vibrator 2 via wiring or the like (not shown) so as to be able to apply a voltage. The second electrode portion 52 may be in a shape other than the frame shape. The second electrode portion 52 may include multiple sections. Also, the shape, arrangement, and the like of the second electrode portion 52 may be changed as appropriate.

The mounting substrate 3 includes wirings (not shown) on the lower substrate 4, the wirings being connected to the surface electrode 23 of the vibrator 2 and being electrically independent of the multiple first electrode portions 51. For example, the multiple wirings (not shown) are provided, and each of the wirings is disposed to extend over the groove 41 on the lower substrate 4 so that one end is connected to the second electrode portion 52 and the other end connected to a portion directly below the connection portion 6 to electrically connecting therebetween. This allows the mounting substrate 3 to apply a voltage to the surface electrode 23 of the vibrator 2 via the second electrode portion 52 and the wirings (not shown).

The connection portion 6 is a member disposed between the mounting portion 22 of the vibrator 2 and the mounting substrate 3, and connecting a part of the mounting portion 22 to the mounting substrate 3. As shown in FIG. 7, for example, the connection portion 6 includes multiple linear portions 61 each extending linearly along a predetermined direction in the top view, and these linear portions 61 are integrated into one piece. The connection portion 6 is, for example, provided by a bonded portion between the vibrator 2 and the mounting substrate 3 at which the vibrator 2 and the mounting substrate 3 are directly bonded to each other, or a separate part that is made of a material separate from the vibrator 2 and the mounting substrate 3. In the latter case, the main portion of the connection portion 6 is made of any bonding material, such as an ultraviolet-curable resin material, a thermosetting resin material, or a die-attach film. The connection portion 6 is, for example, formed with a conductive path (not shown) on its surface, its inside, or on its surface and inside. The conductive path is made of a conductive material. Thus, the mounting substrate 3 and the surface electrode 23 of the vibrator 2 are electrically connected by the conductive path.

For ease of explanation, as shown in FIG. 7, a point located at the center of the bonded area of the mounting substrate 3 with the mounting surface 22b of the vibrator 2, when viewed from above, will be referred to as a “mounting center C” hereinafter. On the xy plane, a radial direction having an axis as a virtual straight line passing through the mounting center C in the thickness direction of the mounting substrate 3 is referred to as a “substrate radial direction D1”. Also, a circumferential direction about the virtual straight line as the axis is referred to as a “substrate circumferential direction D2”. In FIG. 7, for ease of viewing, only one substrate radial direction D1 is shown as a representative example. However, on the mounting substrate 3, there are multiple substrate radial directions D1, which radially extend from the mounting center C as the axis in directions of 0° to 360° on the xy plane.

For example, the multiple linear portions 61 extend straight, but along different substrate radial directions D1 starting from the mounting center C. The multiple linear portions 61 are evenly arranged so that the angles between two adjacent linear portions 61 are approximately the same. Specifically, the multiple linear portions 61 are arranged along node directions D3 that correspond to the positions of the vibration nodes 211S when the rim 211 of the vibrator 2 is vibrated in the resonant mode of n=k.

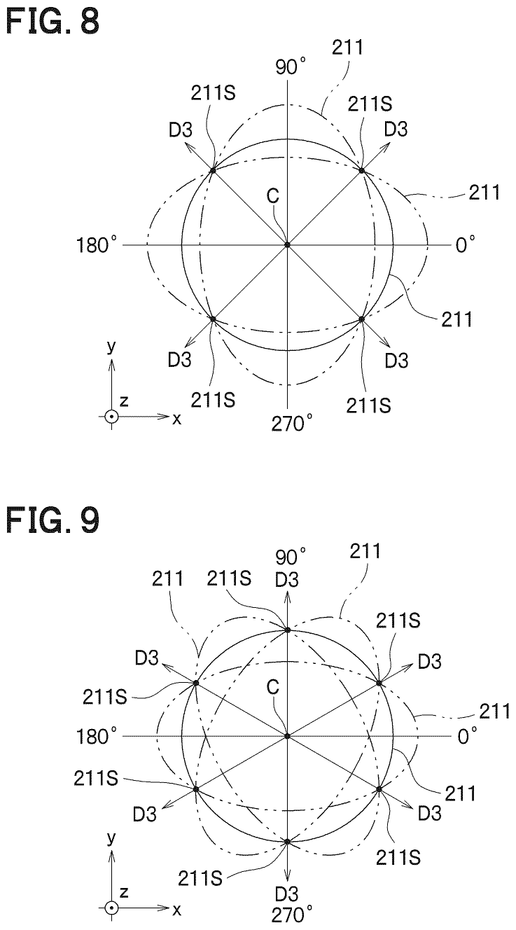

The node direction D3 is a direction along the substrate radial direction D1 and passes through the node 211S, which is a vibration node generated when the rim 211 of the vibrator 2 is vibrated in the resonant mode of n=k, as shown in FIGS. 8 and 9, for example. The direction and the number of the node directions D3 vary depending on the resonant mode of the rim 211. In the example of the resonant mode of n=2 shown in FIG. 8, there are four node directions D3 evenly spaced at intervals of 90° in the substrate circumferential direction D2, among the substrate radial directions D1. For example, assumed that the right direction on the plane of FIGS. 8 and 9 is 0°, the upward direction is 90°, the left direction is 180°, and the downward direction is 270° in a counterclockwise direction, and the drive electrodes or detection electrodes are arranged in these orientations. In this arrangement, in the case of the resonant mode of n=2, the node directions D3 are in the directions of 45°, 135°, 225°, and 315°, as shown in FIG. 8. In the case of the resonant mode of n=3, the node directions D3 are six directions along the substrate radial directions D1 that are equally spaced at 60° intervals in the substrate circumferential direction D2, that is, 30°, 90°, 150°, 210°, 270°, and 330°, for example, as shown in FIG. 9. In other words, the node directions D3 are the same in number as the number 2k of the nodes 211S of the rim 211 generated in the resonant mode of n=k, and are the directions with the number of 2k evenly spaced at intervals of (180/k)° in the substrate circumferential direction D2. Note that the number and the direction of the node directions D3 vary depending on the resonant mode of the vibrator 2, the arrangement and the number of the first electrode portions 51, and the allocation of the drive electrodes and detection electrodes. For this reason, the number and the orientation of the multiple linear portions 61 of the connection portion 6 are determined in accordance with the number and the orientation of the node directions D3 that are generated depending on the pre-designed operation mode of the inertial sensor 1, that is, the resonant mode of the vibrator 2 and the arrangements and the like of the first electrode portions 51.

The inertial sensor 1 of the present embodiment has the basic configurations as described hereinabove. In FIG. 1 and other figures, the configuration in which the mounting substrate 3 has sixteen first electrode portions 51 is illustrated as a representative example. However, the inertial sensor 1 is not limited to this configuration, and the number and arrangement of the first electrode portions 51 can be changed as appropriate.

### <Effects of Connection Portion>

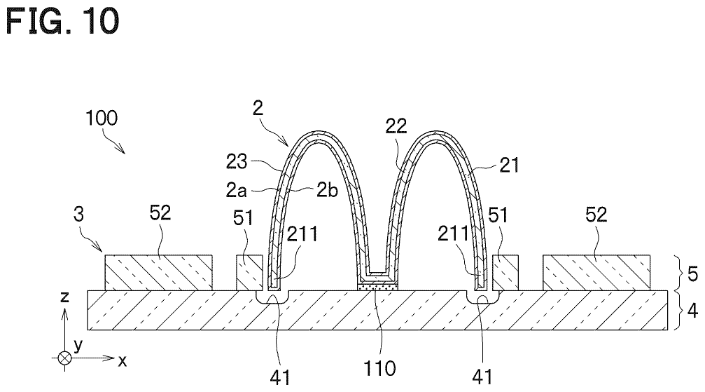

Next, the effects of the connection portion 6 will be explained in comparison with an inertial sensor 100 of a comparative example shown in FIG. 10. In the inertial sensor 100 of the comparative example, the entirety of the mounting surface 22b of the vibrator 2 is bonded and fixed to the mounting substrate 3.

As shown in FIG. 10, in the inertial sensor 100 of the comparative example, the mounting surface 22b of the vibrator 2 is entirely bonded and fixed to the mounting substrate 3 by any bonding material 110 made of gold-tin or the like. In the inertial sensors 1 and 100, when the vibrator 2 is vibrated in the resonant mode of such as n=2, it is preferable that the Q factor of the vibrator 2 in this resonant mode is high in order to achieve higher accuracy.

The Q factor is obtained by the sum of Q_{TED}, which is determined by the thermal properties of the material, and Q anchor, which is determined by the dissipation of vibration from the fixed portion of the vibrator 2 to the mounting substrate 3. The “TED” in Q_{TED} is an abbreviation for thermoelastic dissipation. The Q_{TED} is the Q factor resulting from thermoelastic loss, that is, energy loss. The Q anchor becomes larger as the dissipation of vibration energy due to the transmission of vibration from the fixed portion of the vibrator 2 to the mounting substrate 3, that is, the anchor loss, becomes smaller. In other words, the Q factor of the vibrator 2 is determined by the Q_{TED}, which depends on the constituent material of the vibrator 2, and the Q anchor, which depends on the state of bonding and fixing between the vibrator 2 and the mounting substrate 3.

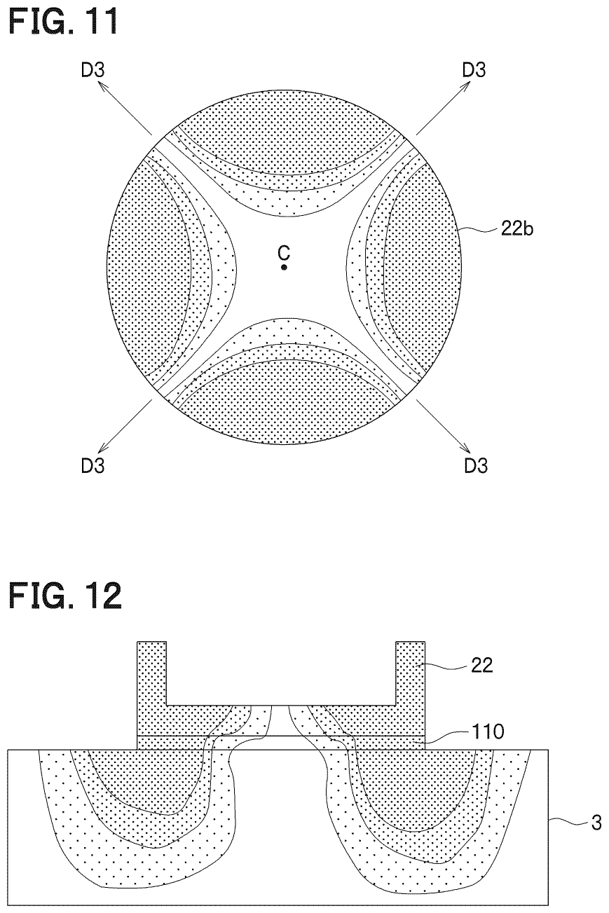

The inventors performed a modal analysis on the inertial sensor 100 of the comparative example, and found that, as shown in FIGS. 11 and 12, in the fixed portion of the mounting surface 22b, a large amount of vibration energy was dissipated from positions corresponding to the directions located at the antinode of the vibration amplitude of the rim 211 in the resonant mode. On the other hand, in the fixed portion of the mounting surface 22b, the dissipation of vibration energy from positions corresponding to the directions located at the nodes in the vibration amplitude of the rim 211 in the resonant mode was smaller than that of the positions corresponding to the directions located at the antinode. Further, in the inertial sensor 100 of the comparative example, the dissipation of vibrational energy was relatively small near the center of the bonded portion in the fixed portion of the mounting surface 22b, and the dissipation of vibrational energy was relatively large at positions corresponding to the directions located at the antinode in the resonant mode of the rim 211 and apart from the center of the bonded portion.

The results shown in FIGS. 11 and 12 were obtained by vibrating the vibrator 2 of the inertial sensor 100 of the comparative example in the resonant mode of n=2, and analyzing the resonant frequency obtained in this vibration state and the shape of the vibrator 2 at that time by using known vibration analysis techniques. In FIGS. 11 and 12, in order to make the dissipation of vibration energy easier to understand, the areas where the magnitude of transmission of vibrations of the vibrator 2 is greater are shown with hatching that is closer to black, that is, thicker hatching.

In contrast, the inertial sensor 1 of the present embodiment has the connection portion 6 having multiple straight linear portions 61 formed between the mounting surface 22b of the vibrator 2 and the mounting substrate 3, and the mounting surface 22b of the vibrator 2 is partially bonded and fixed to the mounting substrate 3 via the connection portion 6. In other words, the inertial sensor 1 has a structure in which the vibrator 2 and the mounting substrate 3 are bonded by the multiple linear portions 61 that are extended along the node directions D3 caused in the resonant mode of the vibrator 2, and other portions of the mounting surface 22b are not fixed to the mounting substrate 3. As a result, in the inertial sensor 1, the transmission of vibrations is restricted at the positions corresponding to the directions located at the antinode of the vibrations of the rim 211 in the resonant mode of the vibrator 2 to the mounting substrate 3, and hence the dissipation of vibration energy due to the anchor loss is suppressed. Therefore, in the inertial sensor 1, the Q anchor, and therefore the Q factor are increased. As such, the inertial sensor 1 is capable of detecting angular velocity with higher accuracy than the comparative example.

### Manufacturing Method

Next, an example of a manufacturing process for the inertial sensor 1 of the present embodiment will be described. Since the processes for forming the vibrator 2 and the mounting substrate 3 have been described hereinabove, the process for bonding the vibrator 2 and the mounting substrate 3 will be mainly described hereinafter.

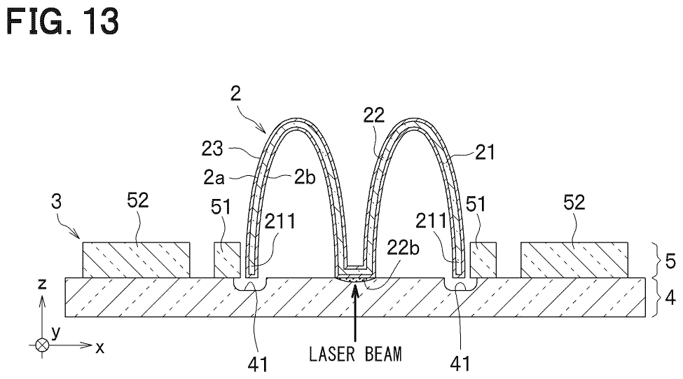

The vibrator 2 and the mounting substrate 3 are prepared, and the vibrator 2 is transported using a transport device (not shown) so that the mounting surface 22b is placed on the mounting substrate 3. Then, as shown in FIG. 13, for example, a laser beam is applied from the mounting substrate 3 side to the interface between the mounting surface 22b and the mounting substrate 3, to cause at least one of the lower substrate 4 or the mounting surface 22b to be partially melted. Then, the melted portion is re-solidified. As a result, the mounting surface 22b and the mounting substrate 3 are bonded to each other. The connection portion 6 is formed, for example, by the process described hereinabove.

The multiple linear portions 61 of the connection portion 6 can be formed, for example, by a first method in which the vibrator 2 and the mounting substrate 3 are temporarily fixed together and then actually resonated to confirm the node directions D3, and the laser beam is applied along the confirmed node directions D3. Alternatively, a second method may be adopted in which the multiple linear portions 61 corresponding to the resonant mode of n=k are formed in advance, and the node directions D3 are aligned with the extension directions of the linear portions 61 by controlling the voltage application from the drive electrode. In other words, it is sufficient that the extension directions of the linear portions 61 and the node directions D3 coincide with each other when the vibrator 2 is driven in the resonant mode. Thus, the multiple linear portions 61 may be formed in accordance with the node directions D3, or the drive control may be performed to align the multiple linear portions 61 with the node directions D3.

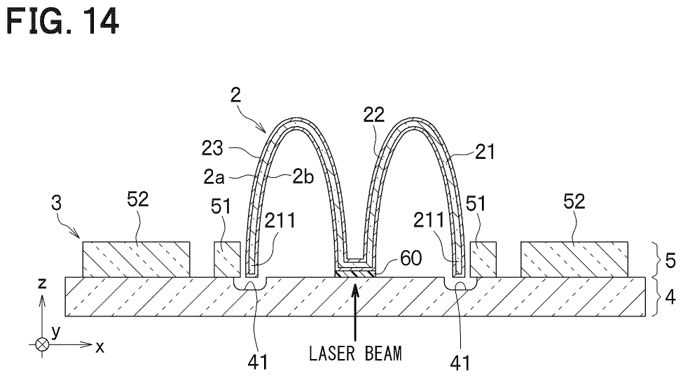

The connection portion 6 may be formed, for example, as shown in FIG. 14, by placing a bonding material 60 made of an ultraviolet-curable resin material on the mounting substrate 3 using a dispenser or the like, placing the vibrator 2 on top of the bonding material 60, and irradiating the bonding material 60 with the laser beam from the mounting substrate 3 side to cure the bonding material 60. Alternatively, a thermosetting resin material may be used as the bonding material 60. In this case, the connection portion 6 may be formed by heating the bonding material 60 by applying the laser beam from the mounting substrate 3 side to cure the bonding material 60.

Alternatively, the connection portion 6 may be formed by using a die attach film as the bonding material 60. The bonding material 60 is heated to fix the vibrator 2 to the mounting substrate 3 over the entire area of the bonding material 60, and then is irradiated with the laser beam from the mounting substrate 3 side to peel off unnecessary bonding portions from the vibrator 2. In this case, the laser beam is applied to portions of the cured bonding material 60 other than the portions corresponding to the node directions D3.

Through the above-described bonding process, the vibrator 2 is bonded to the mounting substrate 3, and the connection portion 6 having the multiple linear portions 61 which are integrated near the mounting center C is formed. In this way, the inertial sensor 1 of the present embodiment is manufactured.

In FIG. 7, the connection portion 6 having a cross shape in which the four linear portion 61 along the substrate radial directions D1 are arranged at 90° intervals and integral with each other is illustrated as a representative example. This connection portion 6 corresponds to the case in which the resonant mode of the vibrator 2 is n=2. However, the connection portion 6 is not limited to this representative example. For example, when the resonant mode of the vibrator 2 is n=3, the connection portion 6 has a configuration in which six straight linear portions 61 extending along the substrate radial directions D1 from the mounting center C as the axis are arranged at 60° intervals, when viewed from above, and are integrated near the mounting center C. In this way, the shape of the connection portion 6 is appropriately changed depending on the resonant mode of the vibrator 2.

According to the present embodiment, the inertial sensor 1 has the configuration in which the mounting surface 22b of the vibrator 2 is partially bonded to the mounting substrate 3 via the connection portion 6, and the connection portion 6 has the multiple linear portions 61 along the node directions D3. Therefore, when the vibrator 2 of the inertial sensor 1 is driven in a resonant mode, it is less likely that vibrations will be transmitted to the mounting substrate 3 from the portions of the mounting surface 22b, the portions corresponding to the directions of the antinode in the standing wave vibration pattern of the rim 211, and hence the anchor loss is suppressed. Therefore, in the inertial sensor 1, the Q factor of the vibrator 2 is improved and the sensor accuracy can be further improved, as compared to the configuration in which the entire mounting surface 22b of the vibrator 2 is bonded and fixed to the mounting substrate 3.

### Second Embodiment

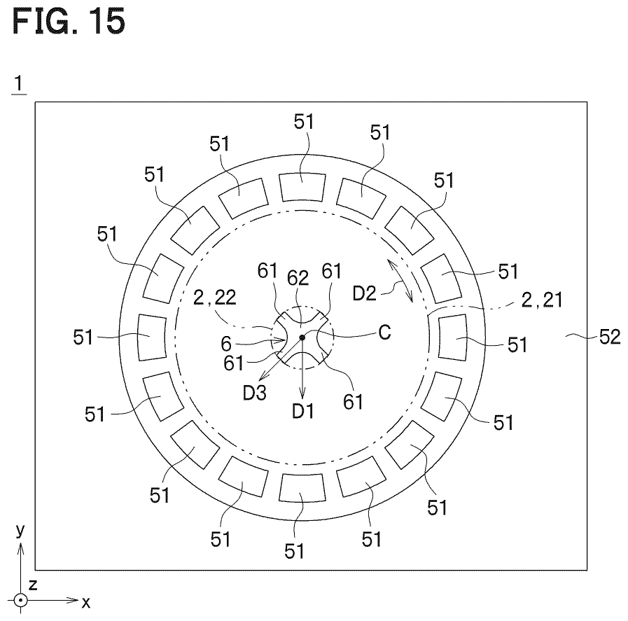

An inertial sensor 1 according to a second embodiment will be described with reference to FIG. 15.

In FIG. 15, similar to FIG. 7, the outline of the vibrator 2 is indicated by a two-dot chain line, and the outline of the connection portion 6 is indicated by a solid line in order to make the connection portion 6 easier to see.

The inertial sensor 1 of the present embodiment differs from the inertial sensor 1 of the first embodiment in that the connection portion 6 includes a connection central portion 62 that is wider than the linear portions 61, as shown in FIG. 15, for example. Hereinafter, this difference will be mainly described.

In the present embodiment, the connection portion 6 includes the multiple linear portions 61 and the connection central portion 62 that connects the linear portions 61 together, and the multiple linear portions 61 and the connection central portion 62 are integrated into one piece. The multiple linear portions 61 are formed only in the area directly below the mounting surface 22b and in the vicinity of the periphery of the mounting surface 22b. The connection central portion 62 is formed in a predetermined region including the mounting center C when viewed from above, and its entire area is wider than the multiple linear portions 61. The width herein refers to the width in the substrate circumferential direction D2. The connection central portion 62 has a curved shape in which the portion connecting the adjacent linear portions 61 is recessed toward the mounting center C, for example.

Also in the present embodiment, the inertial sensor 1 can achieve the similar effects to those of the first embodiment. In addition, since the connection portion 6 has the connection central portion 62 that is wider than the multiple straight linear portions 61, the bonding area between the vibrator 2 and the mounting substrate 3 increases, and thus the effect of improving the bonding reliability can be further achieved.

### Third Embodiment

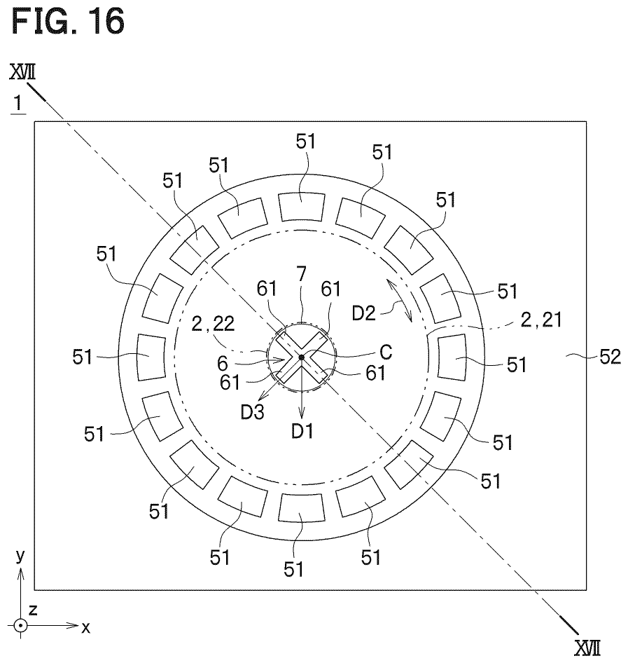

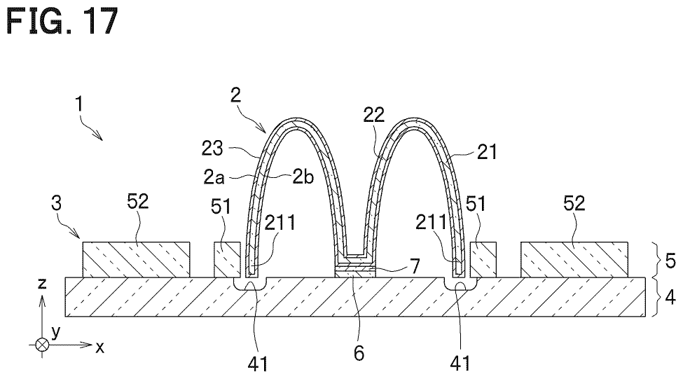

An inertial sensor 1 according to a third embodiment will be described with reference to FIGS. 16 and 17.

In FIG. 16, similar to FIG. 15, the outline of the vibrator 2 is indicated by a two-dot chain line, and the outline of the shim 7 is indicated by a solid line.

The inertial sensor 1 of the present embodiment differs from the inertial sensor 1 of the first embodiment in that the inertial sensor 1 further includes a shim 7 disposed between the connection portion 6 and the vibrator 2, as shown in FIG. 16, for example. Hereinafter, this difference will be mainly described.

The shim 7 is a reinforcing member that is disposed between the vibrator 2 and the connection portion 6 and that improves the bonding strength between the vibrator 2 and the mounting substrate 3, as shown in FIG. 17, for example. The shim 7 is, for example, in the shape of a disk having substantially the same planar size as the mounting surface 22b. The shim 7 is made of a material that can be bonded to the lower substrate 4, such as borosilicate glass. The shim 7 is bonded to the mounting surface 22b of the vibrator 2 by a bonding material (not shown) such as a thermosetting resin material or an ultraviolet-curable resin material containing a filler of a conductive material, and is electrically connected to the surface electrode 23. The shim 7 has a conductive film (not shown) formed on its surface, and is configured to be able to electrically connect the surface electrode 23 of the vibrator 2 and the mounting substrate 3.

The inertial sensor 1 of the present embodiment is manufactured by first bonding one of the mounting surface 22b or the connection portion 6 of the vibrator 2 to the shim 7, and then bonding the other to the shim 7. Similar to the first embodiment, the connection portion 6 is made by melting and re-solidifying a part of the lower substrate 4 or by a resin material that is cured by heat or ultraviolet light.

Also in the present embodiment, the inertial sensor 1 can achieve the similar effects to those of the first embodiment. In addition, since the inertial sensor 1 has the shim 7 between the vibrator 2 and the connection portion 6, even if it is difficult to ensure the bonding strength between the vibrator 2 and the connection portion 6, the bonding strength with the connection portion 6 can be ensured by the shim 7, thereby obtaining the effect of improving the bonding reliability.

In FIG. 16, similar to the first embodiment described above, the configuration in which the connection portion 6 has only the multiple linear portions 61 is illustrated as a representative example. However, the inertial sensor 1 is not limited to this example, and the connection portion 6 may have a configuration similar to that of the second embodiment described above.

### Fourth Embodiment

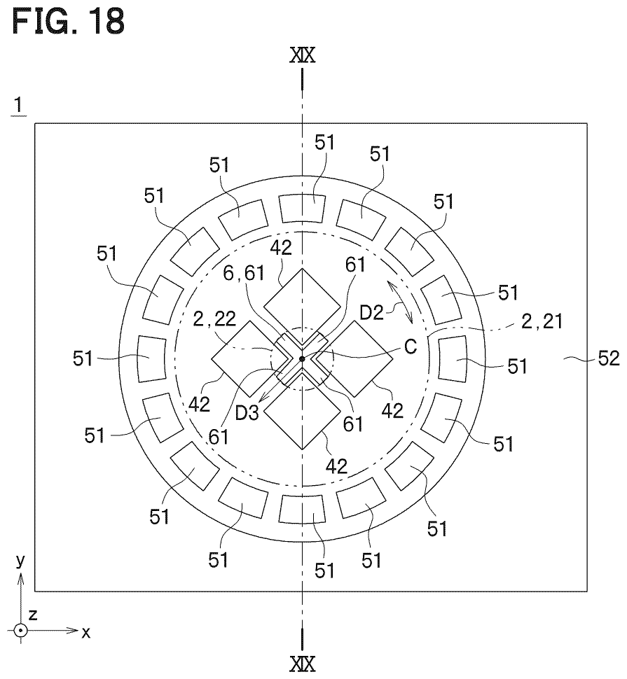

An inertial sensor 1 according to a fourth embodiment will be described with reference to FIGS. 18 to 20.

In FIG. 18, similarly to FIG. 15, the outline of the vibrator 2 is indicated by a two-dot chain line, and the outline of the connection portion 6 is indicated by a solid line.

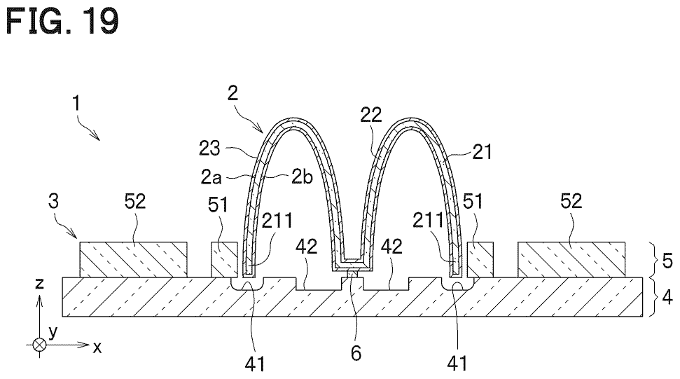

As shown in FIGS. 18 and 19, the inertial sensor 1 of the present embodiment differs from that of the first embodiment in that the mounting substrate 3 is formed with a recess 42. Hereinafter, this difference will be mainly described.

In the mounting substrate 3, for example, when viewed from above, a region surrounded by the multiple first electrode portions 51 is defined as an inner region, and the recess 42 is formed in a portion of the inner region that is positioned in a direction different from the node direction D3. In other words, the mounting substrate 3 has the recess 42 in a part of the inner region of the lower substrate 4 that is different from the portion where the connection portion 6 is disposed.

The recesses 42 are formed, for example, in multiple areas located at directions different from the node directions D3, and serve to suppress dissipation of the vibration energy of the vibrator 2 in the resonant mode to the mounting substrate 3. In other words, in the inertial sensor 1 of the present embodiment, the recesses 42 are formed in the areas corresponding to the antinode of the standing wave vibration pattern of the rim 211, thereby reducing the portion that impedes the vibration of the vibrator 2 and reducing the dissipation of vibration energy of the vibrator 2. The recess 42 may have any shape, such as a circle, an ellipse, or a polygon, when viewed from above, and the depth of the recess 42 may be changed as appropriate. Further, the outer shape and size of the recess 42 can be appropriately changed depending on the shape of the connection portion 6.

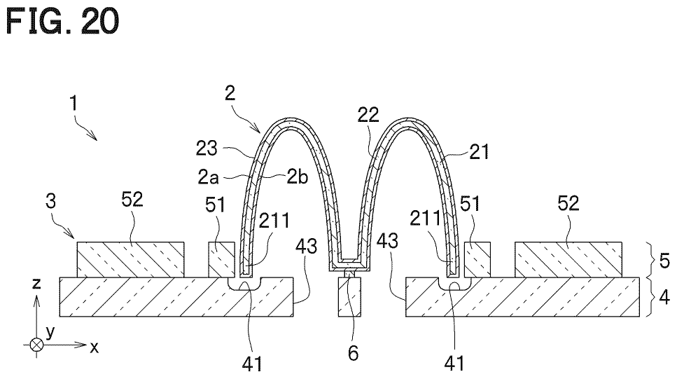

For example, in place of the recess 42, the inertial sensor 1 may have a through hole 43, as shown in FIG. 20, for example. Also in this configuration, the inertial sensor 1 can achieve the similar effects to those of the configuration having the recess 42.

Also in the present embodiment, the inertial sensor 1 can achieve the similar effects to those of the first embodiment. In addition, by having the recess 42 or the through hole 43 in the inner region, the inertial sensor 1 eliminates any portions that impede the vibrations of the vibrator 2 in the drive mode. As such, the dissipation of the vibration energy to the mounting substrate 3 is reduced, and the decrease in the Q factor can be further suppressed.

### Fifth Embodiment

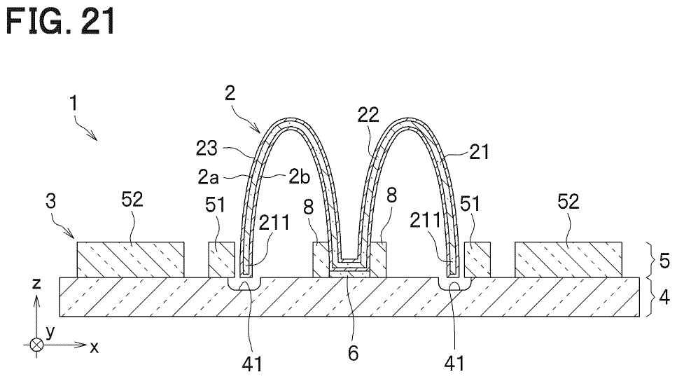

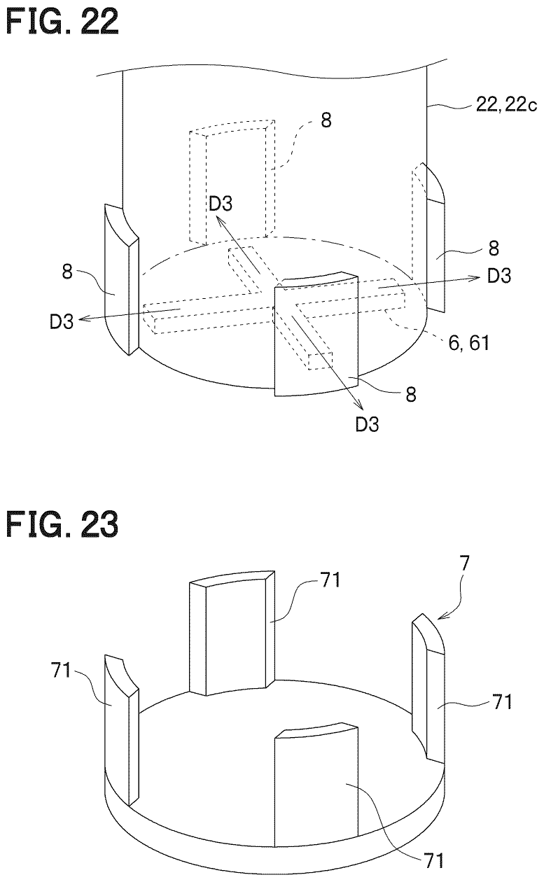

An inertial sensor 1 according to a fifth embodiment will be described with reference to FIGS. 21 and 22.

In FIG. 22, the outer contour of a part of the support section 8 described later and the outer contour of the connection section 6, which are hidden by the mounting portion 22 of the vibrator 2 on the mounting substrate 3, are indicated by dashed lines, and a part of the outer contour of the mounting portion 22, which is not visible from the angle in FIG. 22, is indicated by a dotted line.

The inertial sensor 1 of the present embodiment differs from the inertial sensor 1 of the first embodiment in that it further includes the support portion 8 that partially covers a side surface 22c of the mounting portion 22 of the vibrator 2, for example, as shown in FIG. 21. Hereinafter, this difference will be mainly described.

The support portion 8 is formed on the mounting substrate 3 as a pillar, as shown in FIG. 21, for example. The support portion 8 covers a part of the side surface 22c of the vibrator 2, and serves as a reinforcing member that improves the bonding strength between the vibrator 2 and the mounting substrate 3. The multiple support portions 8 are formed as a part of the upper substrate 5, together with the first electrode portions 51 and the second electrode portions 52 by etching such as DRIE, for example. The support portions 8 have the shape to be along the side surface 22c of the mounting portion 22. For example, when the vibrator 2 is driven in the resonant mode of n=2, the support portions 8 are disposed so as to cover the portions of the side surface 22c that correspond to the four node directions D3, as shown in FIG. 22. As a result, the support portions 8 improve the bonding strength between the vibrator 2 and the mounting substrate 3 while suppressing the dissipation of the vibration energy of the vibrator 2.

The number, arrangement, shape, and the like of the support portions 8 can be appropriately changed depending on the resonant mode of the vibrator 2 and the shape of the side surface 22c. For example, the support portion 8 may be configured such that a conductive film (not shown) is formed on the surface facing the vibrator 2, thereby supporting the vibrator 2 more stably and electrically connecting the surface electrode 23 of the vibrator 2 to the mounting substrate 3. Alternatively, the support portion 8 may not have a conductive film and may only serve to support the vibrator 2 more stably. For example, in order to restrict the vibrations during driving from being unnecessarily transmitted to the mounting substrate 3, the vibrator 2 has a bare portion on the side surface 22c that corresponds to the position of the antinode in the resonant mode.

Also in the present embodiment, the inertial sensor 1 can achieve the similar effects to those of the first embodiment. Further, the inertial sensor 1 has the support portions 8 that cover the portions of the side surface 22c of the vibrator 2 that are located at the node directions D3, thereby achieving the effect of further improving the bonding strength between the vibrator 2 and the mounting substrate 3.

### OTHER EMBODIMENTS

Although the present disclosure has been described in accordance with the embodiments, it is understood that the present disclosure is not limited to such examples or structures. The present disclosure encompasses various modifications and variations within the scope of equivalents. In addition, various combinations and forms, as well as other combinations and forms that include only one element, more, or less, are within the scope and range of spirit of the present disclosure.

(1) In the third embodiment, the inertial sensor 1 may be configured such that the shim 7 has a plurality of pillar support portions 71 that cover the portions of the side surface 22c that are located at the node directions D3, as shown in FIG. 23, for example. The number, arrangement, shape, and the like of the support portions 71 can be appropriately changed depending on the number and direction of the node directions D3 and the shape of the side surface 22c of the vibrator 2. In this case, in the inertial sensor 1, the effects of the third embodiment described above can be further improved by the support portions 71. In this way, the inertial sensor 1 can have a structure in which some or all of the components of the above embodiments are freely combined, except in cases where they are clearly incompatible. For example, the inertial sensor 1 may be configured to include the connection portion 6 with a shape including the connection central portion 62, the recess 42, the through hole 43, the shim 7 and the support portion 8.

(2) In each of the embodiments described above, as shown in FIG. 11, the case in which the region where the dissipation of the vibration energy is small occurs at the node directions D3 of the vibrator 2 has been illustrated. However, in a case where a region where the dissipation of the vibration energy is relatively small occurs in a curved shape, the configuration of the connection portion 6 may be changed. For example, a region of the mounting surface 22b where the dissipation of vibration energy is relatively small is defined as a low-dissipation region, and the low-dissipation regions are assumed to be generated so as to connect the mounting center C and the nodes 211S in a shape of curved line when viewed from above. In such a case, the connection portion 6 may be configured to have multiple curved portions along the curved low-dissipation regions.

(3) The constituent element(s) of each of the embodiments described above is/are not necessarily essential unless it is specifically stated that the constituent element(s) is/are essential in the embodiment, or unless the constituent element(s) is/are obviously essential in principle. Further, in each of the embodiments described above, when numerical values such as the number, quantity, range, and the like of the constituent elements of the embodiment are referred to, except in the case where the numerical values are expressly indispensable in particular, the case where the numerical values are obviously limited to a specific number in principle, and the like, the present disclosure is not limited to the specific number. In each of the embodiments described above, when the shape of an element or the positional relationship between elements is mentioned, the present disclosure is not limited to the specific shape or positional relationship unless otherwise particularly specified or unless the present disclosure is limited to the specific shape or positional relationship in principle.

What is claimed is:

1. An inertial sensor comprising:
a mounting substrate having a plurality of electrodes arranged apart from each other;
a vibrator having a hollow rim that vibrates in a resonant mode due to an electrostatic force from a part of the plurality of electrodes, and a mounting portion that is connected to the mounting substrate, the mounting portion having a mounting surface that faces the mounting substrate; and
a connection portion disposed between the mounting surface of the mounting portion and the mounting substrate, wherein
the plurality of electrodes is arranged in a ring shape around the rim at a distance from the rim,
a center of a connection area between the mounting surface and the mounting substrate is referred to as a mounting center, a radial direction that extends from a virtual straight line passing through the mounting center in a thickness direction of the mounting substrate as an axis is referred to as a substrate radial direction, and a direction extending along the substrate radial direction and passing through a position of a vibration node of the rim that vibrates in the resonant mode of n=k, in which k is an integer of 2 or more, is referred to as a node direction, and
the connection portion has a plurality of linear portions extending linearly along the node directions.

2. The inertial sensor according to claim 1, wherein
the connection portion has a connection central portion that connects the plurality of linear portions near the mounting center, and
the connection central portion has a curved shape that is recessed toward the mounting center at a portion connecting between two adjacent linear portions.

3. The inertial sensor according to claim 1, further comprising:
a shim disposed between the mounting surface and the connection portion and bonded to the connection portion.

4. The inertial sensor according to claim 1, wherein
the mounting substrate has at least one recess or through hole in a region surrounded by the plurality of electrodes and at a position different from the connection portion.

5. The inertial sensor according to claim 1, wherein
the mounting portion of the vibrator has a side surface adjacent to the amounting surface, and
the mounting substrate further includes a support portion covering a portion of the side surface of the mounting portion, the portion of the side surface being at a position corresponding to the node direction.

6. The inertial sensor according to claim 1, wherein
the connection portion has the plurality of linear portions with a number of 2k that is a same number as the node directions, and
an angle defined between two adjacent node directions is 180°/k.

7. A method for manufacturing an inertial sensor, comprising:
preparing a mounting substrate and a vibrator, the mounting substrate having a plurality of electrodes arranged apart from each other, the vibrator having a hollow rim that vibrates in a resonant mode due to an electrostatic forces from a part of the plurality of electrodes and a mounting portion having a mounting surface; and
bonding the mounting substrate and the vibrator, which is arranged on the mounting substrate so that the mounting surface of the mounting portion faces the mounting substrate, by applying a light to the mounting surface from a side of the mounting substrate, wherein
a center of a connection area between the mounting surface and the mounting substrate is referred to as a mounting center, a radial direction that extends from a virtual straight line passing through the mounting center in a thickness direction of the mounting substrate as an axis is referred to as a substrate radial direction, and a direction extending along the substrate radial direction and passing through a position of a vibration node of the rim that vibrates in a resonant mode of n=k, in which k is an integer of two or more, is referred to as a node direction, and
the bonding includes forming a connection portion that includes a plurality of linear portions extending linearly along the node directions by applying the light.

8. The method according to claim 7, wherein
in the bonding of the mounting substrate and the vibrator, the connection portion is formed by melting and re-solidifying at least one of the mounting surface or the mounting substrate by applying a laser beam as the light.

9. The method according to claim 7, wherein
in the bonding of the mounting substrate and the vibrator, an ultraviolet-curable resin material is placed between the mounting surface and the mounting substrate, and the connection portion is formed by curing the ultraviolet-curable resin material by applying an ultraviolet light as the light.

10. The method according to claim 7, wherein
in the bonding of the mounting substrate and the vibrator, a thermosetting resin material is placed between the mounting surface and the mounting substrate, and the connection portion is formed by heating and curing the thermosetting resin material by applying the light.

11. The method according to claim 7, wherein
in the bonding of the mounting substrate and the vibrator, a thermosetting resin material is placed between the mounting surface and the mounting substrate, and
the connection portion is formed: by heating and curing the thermosetting resin material to bond the mounting surface and the mounting substrate to each other; and then applying a laser beam as the light to a part of the cured thermosetting resin material to partially peel off a bonded portion between the mounting surface and the mounting substrate.
